(19) United States
(12) Patent Application Publication
(10) Pub. No.: US 2025/0095026 A1
(43) Pub. Date: Mar. 20, 2025

(54) DYNAMIC SECONDARY CONTENT SELECTION AND OPTIMIZATION

(71) Applicants: DISH Network L.L.C., Englewood, CO (US); DISH Network Technologies India Private Limited, Bangalore (IN)

(72) Inventors: Kalleri Faizel Rehiman, Foster City, CA (US); Vinay W. Tiwari, Englewood, CO (US); Syed Misbah Ahmed, BANGALORE (IN); Mohit Arvind Jichkar, BANGALORE (IN); MD Dilshad Akhtar, BANGALORE (IN)

(21) Appl. No.: 18/634,691

(22) Filed: Apr. 12, 2024

(30) Foreign Application Priority Data
Sep. 18, 2023 (IN) 202311062624

(51) Int. Cl. G06Q 30/0251; G06N 20/00; G06Q 30/0241

(52) U.S. Cl. CPC G06Q 30/0251; G06N 20/00; G06Q 30/0277

(57) ABSTRACT

System and method for utilizing a machine learning mechanism to train a category-determination model that is used to predict a category of a website for selecting secondary content for the website. A secondary content request is received for a target website being presented to a user. The category-determination model is employed to determine a category for the target website. A plurality of top shows is then selected for the category, from which a specific show is selected. The secondary content is selected for the target website based on the selected show. And the selected secondary content is presented to the user via the target website.

### BACKGROUND

Websites generally display primary content and secondary content. The primary content is the content that is supplied by the website, and the secondary content is content that is provided by a third party, such as an advertisement. Over the past several years, websites have tried to provide users with more targeted secondary content. Many websites allow for third parties to bid on and provide such targeted secondary content. Once a bid is won, the winning third party selects and provides the targeted secondary content to the website for display to the user. In selecting the targeted secondary content, the third party often relies on demographic information regarding the user. But as people become more concerned with sharing their demographic information with websites, third parties have had to alter how they select targeted secondary content. It is with respect to these and other considerations that the embodiments herein have been made.

### BRIEF SUMMARY

Embodiments are directed towards systems and methods for utilizing a machine learning mechanism to dynamically train a category-determination model that is used to predict a category of a website for selecting secondary content for the website. In response to receiving a receiving a secondary content request for a target website being presented to a user, the category-determination model is employed to determine a category for the target website. In various embodiments, a machine learning mechanism is employed to train the category-determination model using pre-labeled categories for a plurality of websites and historical content presented on the plurality of websites. Once determined, a plurality of top shows are determined for the category, from which a show is selected. Secondary content is then selected for the target website based on the selected show, which is provided to the user via the target website.

Embodiments described herein improve the optimization, efficiency, and effectiveness of providing secondary content to website users. By dynamically training a category-determination model to predict a category of a website, targeted secondary content can be selected and provided to a user. Such selection systems and methods can reduce the use of demographic information, which improves user privacy and computing resource utilization.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for providing content to a user in accordance with embodiments described herein;

FIG. 2 is a context diagram of a non-limiting embodiment of a system that provide functionality to dynamically select secondary content to be provided to a user in accordance with embodiments described herein;

FIG. 3 illustrates a logical flow diagram showing one embodiment of an overview process for selecting secondary content to provide to a user in accordance with embodiments described herein;

FIG. 4 illustrates a logical flow diagram showing one embodiment of a process for employing machine learning to train a category-determination model to select secondary content for a user in accordance with embodiments described herein; and

FIG. 5 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References herein to the term “user” refer to a person or persons who is or are accessing a website to be displayed on a display device. Accordingly, a “user” more generally refers to a person or persons consuming content on a website. Although embodiments described herein utilize user in describing the details of the various embodiments, embodiments are not so limited. For example, in some implementations, the term “user” may be replaced with the term “viewer” throughout the embodiments described herein.

References herein to the term “content” refer to audio, visual, or audiovisual content that is presented to a user. Examples of content include text, graphics, video, audio, or other information presented to the user, which may include, but is not limited to, television or radio programs, sports broadcasts, news feeds, advertisements, and other types of displayable or audible content. In various embodiments, content presented on a website can include “primary content” or “secondary content” or a combination thereof “Primary content” is content that is selected by a website or its developer or its administrator to be presented to the user via the website. “Secondary content” refers to content that that is selected by a third party, separate from the website, to be presented to the user via the website. For example, in some embodiments, the secondary content may be an advertisement that is presented to the user in a banner or slot on a website.

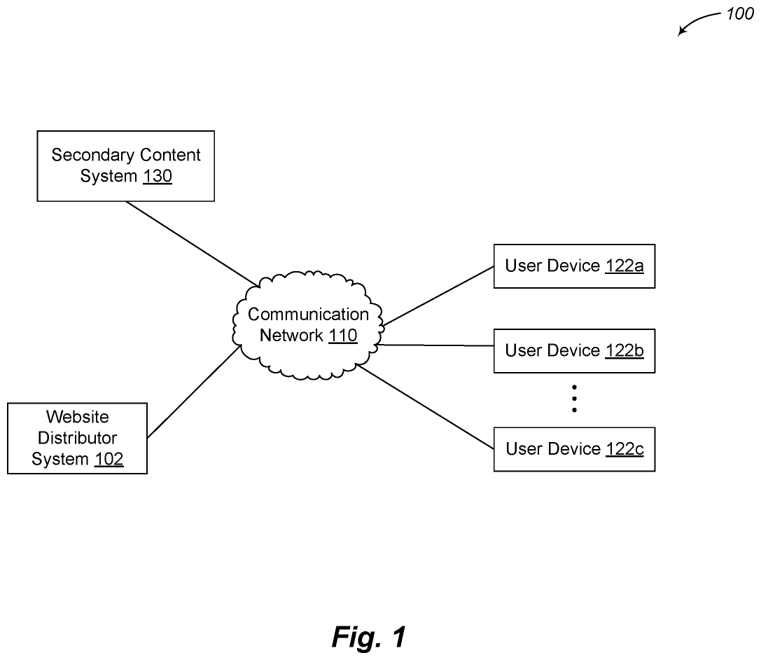

FIG. 1 illustrates a context diagram of an environment 100 for providing content to a user in accordance with embodiments described herein. Environment 100 includes website distributor system 102, secondary content system 130, and user devices 122a-122c, which communicate via communication network 110. The communication network 110 is configured to couple various computing devices to transmit content/data from one or more devices to one or more other devices. Communication network 110 may include one or more wired or wireless networks, which may include the Internet or may include networks configured to access the Internet.

User devices 122a-122c are computing devices that are configured to access and view websites via website distributor system 102. User devices 122a-122c may include mobile phones, smartphones, tablet computers, laptop computers, desktop computers, wearable devices, or other computing devices.

The website distributor system 102 may include one or more computing devices or systems that access and present websites to users of user devices 122a-122c. The website distributor system 102 may include primary content website servers, demand-side platforms (DSPs), secondary content servers, or other computing devices associated with the access and presentation of websites to user devices 122a-122c.

The secondary content system 130 is a computing device or system configured to select and provide secondary content for presentation with a website's primary content via the website distributor system 102. As described herein, the secondary content system 130 utilizes a machine learning or artificial intelligence mechanism to generate a category-determination model, which predicts or selects a category for a target website being accessed by a user device 122. The secondary content system 130 then selects secondary content based on the website category. The secondary content system 130 provides the selected secondary content to the website distributor system 102 to be provided to the user via the target website. Utilization of the category-determination model to predict or select a category for a target website dynamically optimizes the selection of the secondary content for the target website.

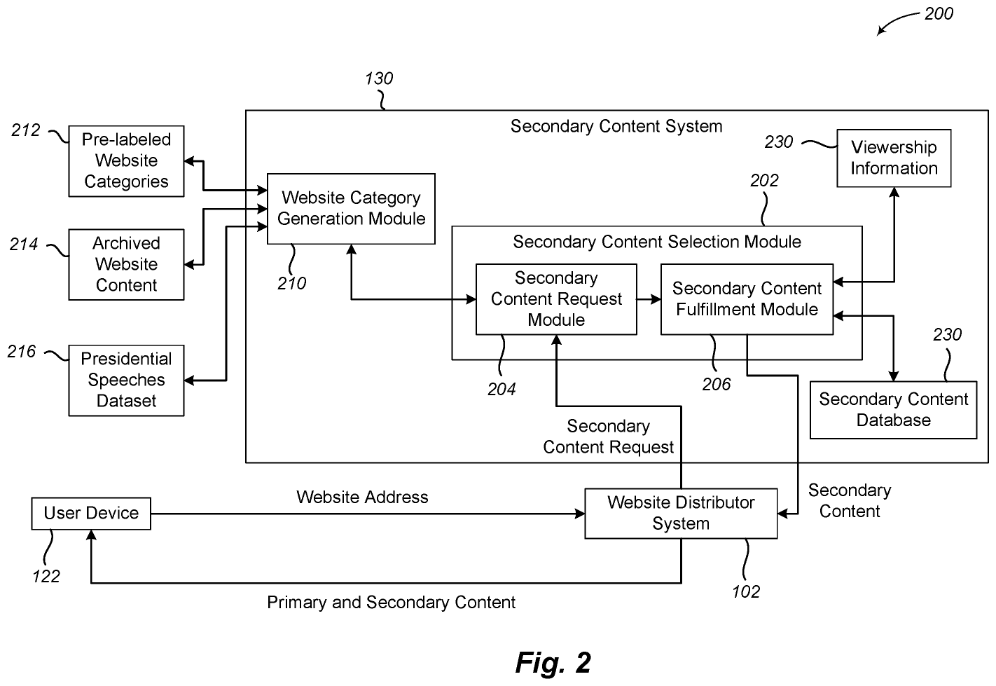

FIG. 2 is a context diagram of a non-limiting embodiment of a system 200 that provide functionality to dynamically select secondary content to be provided to a user in accordance with embodiments described herein.

System 200 includes the secondary content system 130, a user device 122, a website distributor system 102, pre-labeled website categories 212, archived website content 214, and presidential speeches dataset 216.

The pre-labeled website categories 212 is configured to store pre-labeled categories, or sub-categories, for a plurality of websites. These pre-labeled categories may be defined or set by the website developer or by an administrator, or by a third party.

The archived website content 214 is configured to store historical content presented by a plurality of websites. In various embodiments, the archived website content 214 may include or access the Internet Archive: Wayback Machine, which stores snapshots of previous versions or iterations of the content presented on a plurality of websites.

The presidential speeches dataset 216 is configured to store information regarding presidential speeches, such as timing, content, schedule, political parties, candidates, etc.

The website distributor system 102 may include one or a plurality of computing devices or systems associated with the access and presentation of a website to user device 122. In various embodiments, the website distributor system 102 may include a secondary content server (not separately illustrated) associated with the bidding and presentation of secondary content along with primary content for a website. The website distributor system 102 receives a website address for a target website from the user device 122. The website distributor system 102 receives secondary content from the secondary content system 130, combines the secondary content with the primary content for the target website, and provides the combined content to the user device 122 for presentation or display to the user of the user device 122.

The secondary content system 130 includes a website category generation module 210, a secondary content selection module 202, viewership information 230, and a secondary content database 230.

The viewership information 230 is a database or other storage structure that stores information regarding viewership of a plurality of shows. The viewership information 230 may maintain a list of the top shows for each category that can be predicted by the website category generation module 210. The viewership information 230 may be updated hourly, daily, weekly, or at some other interval or time schedule.

The secondary content database 230 is a database or other storage structure that stores a plurality of secondary content or references to access secondary content. In various embodiments, each of the plurality of secondary content is associated with one or more shows that may be listed as a top show in the viewership information 230.

The website category generation module 210 is configured to generate and utilize a category-determination model to predict categories for websites. The website category generation module 210 may access the pre-labeled website categories 212 and the archived website content 214 to obtain pre-labeled categories and historical content, respectively, regarding a plurality of websites. In some embodiments, the website category generation module 210 may also access the websites directly to obtain current content being presented on the websites. In other embodiments, the website category generation module 210 may access the presidential speeches dataset 216 to obtain presidential speeches information.

The website category generation module 210 is configured to employ a machine learning or artificial intelligence mechanism that utilizes the pre-labeled categories, historical content, current content, and the presidential speeches information to train the category-determination model. In various embodiments, the website category generation module 210 may also obtain time or time period information regarding the historical content or the presidential speeches information so that the category-determination model can be trained to predict website categories based on time or time period. In some embodiments, the website category generation module 210 may generate or train a plurality of category-determination models, where each separate model is generated or trained for a different time or time period (e.g., evenings, mornings, weekdays, weekends, specific months, etc.).

The website category generation module 210 is also configured to predict a category for a target website in response to the secondary content system 130 receiving a secondary content request for the target website. In various embodiments, the website category generation module 210 receives a target website address from the secondary content selection module 202. The website category generation module 210 can scrape the target website for the current content. The current content, and in some embodiments a time or time period associated with the secondary content request, can be input into the category-determination model, which outputs a predicted category for the target website. The website category generation module 210 can then provide the predicted category for the target website to the secondary content selection module 202.

In some embodiments, the website category generation module 210 may periodically, or at selected times or at selected time intervals, employ the category-determination model to predict the categories for a plurality of selected websites. In this way, the categories of the plurality of selected websites can be cached for quick access by the secondary content selection module 202.

The secondary content selection module 202 includes a secondary content request module 204 and a secondary content fulfillment module 206. Although the secondary content request module 204 and the secondary content fulfillment module 206 are illustrated as separate modules, embodiments are not so limited. In some embodiments, a single module or a plurality of modules may be employed to perform the functionality of the secondary content request module 204 and the secondary content fulfillment module 206.

The secondary content request module 204 receives a secondary content request for a target website from the secondary content server 224. The secondary content request module 204 provides the target website to the website category generation module 210 and receives the predicted category from the website category generation module 210. The secondary content request module 204 provides the predicted category for the target website to the secondary content fulfillment module 206.

The secondary content fulfillment module 206 is configured to select secondary content for the secondary content request based on the predicted category for the target website. The secondary content fulfillment module 206 accesses the viewership information 230 to obtain a list of the top shows for the predicted category. From this list, the secondary content fulfillment module 206 selects one of the top shows. The secondary content fulfillment module 206 then obtains secondary content for the selected show from the secondary content database 230. The secondary content fulfillment module 206 provides the secondary content to the website distributor system 102 to be combined with the primary content of the target website for providing to the user device 122.

Although the website category generation module 210 and the secondary content selection module 202 are illustrated as separate modules, embodiments are not so limited. In some embodiments, a single module or a plurality of modules may be employed to perform the functionality of the website category generation module 210 and the secondary content selection module 202.

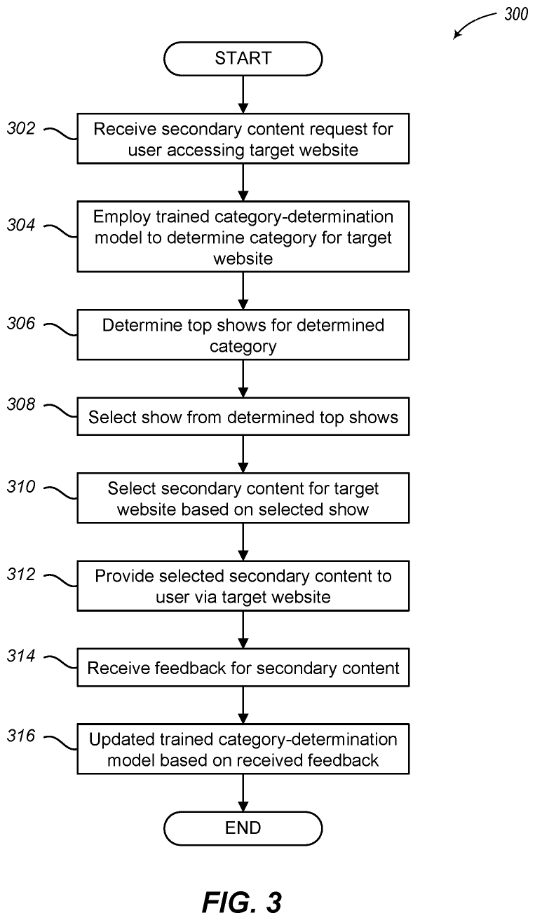

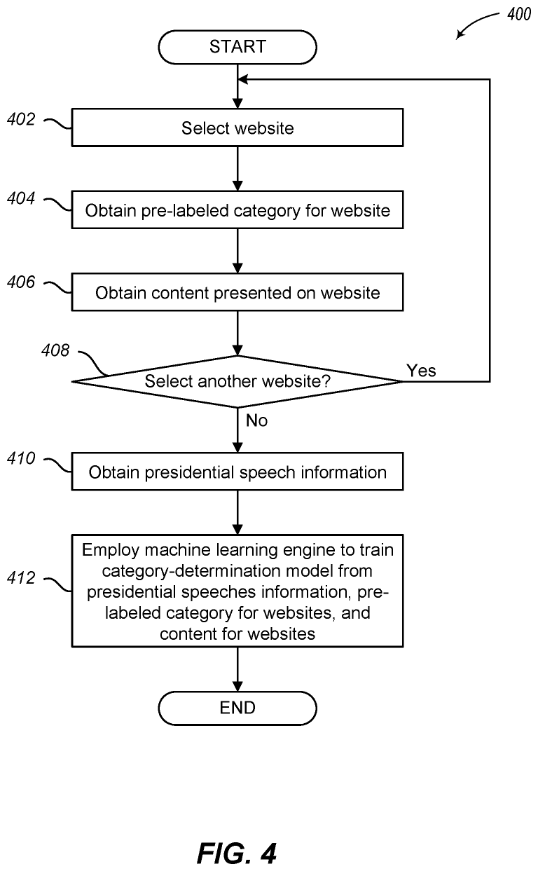

The operation of certain aspects will now be described with respect to FIGS. 3 and 4. Processes 300 and 400 described in conjunction with FIGS. 3 and 4 may be implemented individually or collectively by one or more processors or executed individually or collectively via circuitry on one or more computing devices, such as secondary content system 130 in FIG. 1.

FIG. 3 illustrates a logical flow diagram showing one embodiment of an overview process 300 for selecting secondary content to provide to a user in accordance with embodiments described herein. In various embodiments, the system executing process 300 may be associated with a particular content distributor (e.g., a third party advertiser) that previously won a bid to provide secondary content on a website.

Process 300 begins, after a start block, at block 302, where a secondary content request is received to provide secondary content to a user via a target website. In various embodiments, the secondary content request is received from a secondary content server that is configured to enable third parties to bid on and provide secondary content in response to a user accesses a website, such as via a browser executing on a user device 122. In at least one embodiment, the secondary content request is received along with or after a bid to provide secondary content on the target website has been won.

Process 300 proceeds after block 302 to block 304, where a trained category-determination model is employed to determine a category for the target website. Employing the trained category-determination model to determine or predict a category for the target website optimizes the secondary content selection to be provided with the target website.

In various embodiments, the determined category is one of a plurality of possible categories. For example, the possible categories may include: “sports,” “entertainment,” “liberal news,” and “conservative news.” In other situations and embodiments, other numbers or types of categories may be employed. In some embodiments, sub-categories may also be employed, such as the “sports” category having the subcategories of “baseball,” “football,” “hockey,” and “basketball.” As another example, the category “news” may have the subcategories of “liberal news” and “conservative news.”

In some embodiments, the target website is scrapped to extract or obtain the current content of the website. This current content is used as input to the category-determination model. In various embodiments, the current website content may be pre-processed or vectorized prior to inputting the content into the category-determination model, similar to what is discussed in block 406 in FIG. 4. Based on this input, the category-determination model outputs a predicted category for the target website.

In various embodiments, a time or time period associated with the secondary content request may also be used as input to the category-determination model or used to select the category-determination model from a plurality of models. This time or time period may be a specific time of day, a specific day of the week, a specific time of year, or some combination thereof. As such, the category-determination model predicts a category for the website based on the current content of the website and a time or time period associated with the secondary content request.

As described in more detail herein, a machine learning or artificial intelligence mechanism is employed to train or generate the category-determination model using pre-labeled categories for websites and previously presented content on the websites to predict the category of the website associated with the secondary content request. In some embodiments, presidential speech information may also be used to train the category-determination model. In yet other embodiments, feedback from other users regarding the secondary content may be used to train or re-train the category-determination module.

In some embodiments, the category-determination model may be trained over time, such that the model can predict the website category for different times or different time periods. For example, a specific news website may be categorized as “liberal news” or “conservative news” 11 months out of the year, but in March it may be categorized as “sports” because it reports heavily on college basketball tournaments. As another example, a specific football-news website may normally be categorized as “sports,” but during presidential speeches prior to an election season, the website may be categorized as “news,” or even “liberal news” or “conservative news.” In this way, the category-determination model dynamically predicts the category for different websites over time. In other embodiments, a plurality of category-determination models may be trained, which each separate category-determination model being trained for a different time periods.

In some embodiments, the category-determination model may be generated in response to receiving the secondary content request. In this way, the category-determination model is updated in real time with the secondary content request to capture possible changes in the website category over time. In other embodiments, the category-determination model may be generated at specific intervals over a given time period (e.g., every four hours, once a day, once a week, etc.) for one or a plurality of selected or popular websites. In this way, the category for these selected or popular websites can be cached prior to receiving the secondary content request, but the categories are dynamically updated at the specific intervals throughout the given time period.

In some embodiments, one or a plurality of category-determination models may be further trained and employed to determine a sub-category for the target website.

Process 300 continues after block 304 at block 306, where a plurality of top shows is determined for the category determined at block 304. The plurality of top shows may be a list containing a number of top ranked or top viewed shows for a particular time period for that category. The number of shows may be selected or set by an administrator, such as the top five viewed shows in the last hour or the last week. The plurality of top shows may include television series, movies, sports programs, documentaries, or other types of content provided by the particular content distributor associated with or providing the secondary content, or some combination of different types of content. In at least one embodiment, the sub-category of the website may be used to select or refine the plurality of top shows.

Process 300 proceeds next after block 306 to block 308, where a show is selected from the plurality of top shows determined at block 306. In some embodiments, the show may be randomly selected from the plurality of top shows for the category. In other embodiments, the show may be selected based on other criteria, such as a number of times previously provided to the user, a number of times previously provided to other users, location or demographic information regarding the user or the user device, etc.

Process 300 continues next after block 308 at block 310, where secondary content is selected for the target website based on the selected show. In various embodiments, a plurality of secondary content can be associated with the selected show. The particular secondary content can then be randomly selected or selected based on other criteria, such as a number of times previously provided to the user, a number of times previously provided to other users, location or demographic information regarding the user or the user device, etc.

As one example, assume the category determined at block 304 is “sports.” Next assume the top shows determined at block 306 include “Documentary on Football Team_A,” “A Baseball Story,” “Short Series on Basketball Coaches,” “Football Training Camp Movie,” “Championship Replay.” Then assume the show “Documentary on Football Team_A” is selected at block 308. The secondary content selected at block 310 may be selected from a plurality of previews, short clips, banners, photos, or other advertisements about the “Documentary on Football Team_A.”

Process 300 proceeds after block 310 to block 312, where the selected secondary content is provided to the user via the website. In some embodiments, the secondary content is stitched or combined with the primary content of the website, which is then provided to the user device for presentation to the user.

Process 300 continues after block 312 at block 314, where feedback is received regarding the secondary content. In some embodiments, the feedback may include an indication of whether the user clicked on or interacted with the secondary content, such as watching a preview of the selected show. In other embodiments, the feedback may include an indication whether the user accessed, requested, or obtained additional information regarding the secondary content, such as visiting a website that enables the user to purchase full access to view the content associated with the secondary content.

Process 300 proceeds next after block 314 to block 316, where the trained category-determination model is updated based on the received feedback. In various embodiments, the feedback may be used as an input to the machine learning or artificial intelligence mechanism to retrain or re-generate the category-determination model. In this way, the category-determination model can dynamically change over time to adjust the predicted category of a website over time to account for the effectiveness of the secondary content selected for that website.

After block 316, process 300 terminates or otherwise returns to a calling process to perform other actions.

In some embodiments, block 314 and 316 may be optional and may not be performed. In such embodiments, after block 312, process 300 terminates or otherwise returns to a calling process to perform other actions.

FIG. 4 illustrates a logical flow diagram showing one embodiment of a process 400 for employing machine learning to train a category-determination model to select secondary content for a user in accordance with embodiments described herein. In some embodiments, process 400 may be employed in response to receiving a secondary content request from a website, such as at block 302 or block 304 in FIG. 3. In other embodiments, process 400 may be employed at specific intervals throughout a given time period to have the category-determination model updated throughout the given period but independent from and prior to receiving the secondary content request.

Process 400 begins, after a start block, at block 402, where a website is selected. In some embodiments, the selected website is a website associated with a pre-labeled category, which may include pre-selected or popular websites.

Process 400 proceeds after block 402 at block 404, where pre-labeled category information is obtained for the selected website. In various embodiments, the system maintains or accesses a database that is pre-populated with a category label for the website. Some websites may not have a pre-labeled category, but many popular websites may be pre-labeled with the most common or most accurate category given a set of possible categories. Moreover, some websites may also be pre-labeled with a sub-category.

In at least some embodiments, the website may include a plurality of pre-labeled categories, where each separate pre-labeled category is associated with a specific time or time period. In at least one such embodiment, the plurality of pre-labeled categories and their associated specific time periods may be obtained for the website.

Process 400 continues after block 404 to block 406, where content presented on the website is obtained. This content may include historical content, current content, or some combination thereof.

The historical content may include content that was previously presented to the website. The historical content may be stored in a historical database depicting what content was displayed on the website at a given time. One such historical database is the Internet Archive: Wayback Machine. In at least one embodiment, the data stored on the historical database for the website may be scrapped to extract and obtain the content of the website.

The current content may include content that is currently being presented on the website. The website may be accessed and scrapped to extract and obtain the current content being presented on the website.

In various embodiments, the obtained content may be pre-processed by removing HTML tags and special characters, removing stop words, converting text to lower case, lemmatize words, etc. In some embodiments, text strings in the content may be transformed into a vector based on the frequency that each word in the string occurs in the entire content. This pre-processed and vectorized content may be used as the content input to the machine learning engine or other artificial intelligence mechanism at block 412 to generate the category-determination model.

Process 400 proceeds next after block 406 to decision block 408, where a determination is made whether another website is selected. In some embodiments, a plurality of websites are selected such that their pre-labeled categories and content are obtained at blocks 404 and 406, respectively. In at least one embodiment, each selected website is associated with at least one pre-labeled category to act as a fundamental truth or initial association between content and category from which the category-determination model is trained and generated. If another website is selected, process 400 loops to block 402 to select another website; otherwise, process 400 flows to block 410.

At block 410, presidential speech information is obtained. In various embodiments, the presidential speech information including timing of when presidential speeches have occurred, topics discussed during presidential speeches, parties or candidates involved with presidential speeches, or other data related to presidential speeches. In some embodiments, block 408 may be optional and may not be performed.

Process 400 continues next after block 410 at block 412, were a machine learning engine, or other artificial intelligence mechanism, is employed to generate a category-determination model for predicting categories for websites. In some embodiments, a random forest classifier, deep neural network, support vector machine models, decision tree-based models, or other types of machine learning or artificial intelligence mechanism may be employed.

In various embodiments, the pre-labeled category (or sub-category) and content for each selected website is utilized as training data input for the machine learning engine to generate the category-determination model. In some embodiments, the presidential speech information is also utilized as training data input. In some embodiments, a single category-determination model may be generated to predict website categories for different time periods. In other embodiments, separate category-determination models map be generated to predict website categories for different time periods.

After block 412, process 400 may terminate or otherwise return to a calling process to perform other actions.

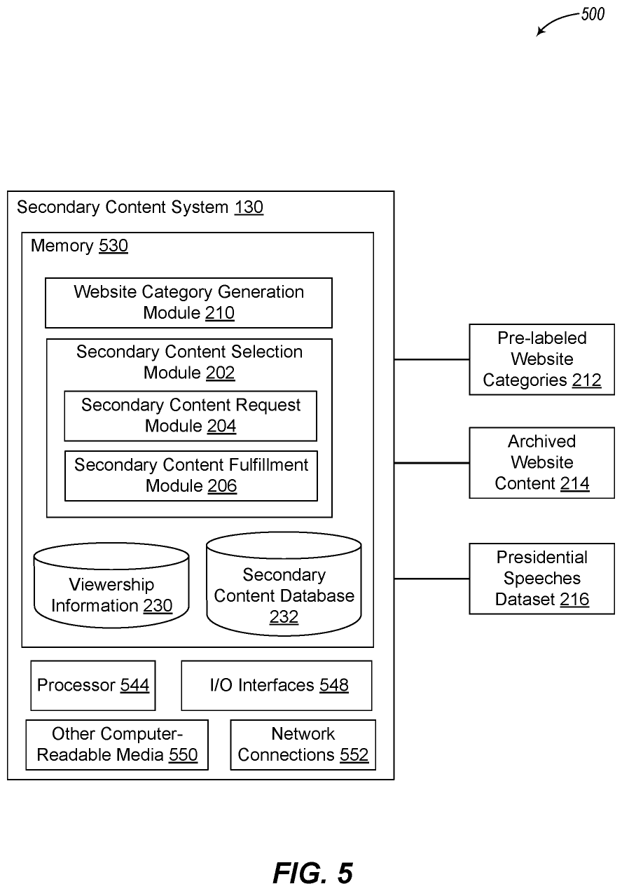

FIG. 5 shows a system diagram that describes one implementation of computing systems for implementing embodiments described herein. System 500 includes secondary content system 130, pre-labeled website categories 212, archived website content 214, and presidential speeches dataset 216.

The secondary content system 130 is a computing system that trains and employs a category-determination model to determine a category for a website and that selects secondary content to be provided to a user of the website based on the determined category, as described herein. One or more special-purpose computing systems may be used to implement the secondary content system 130. Accordingly, various embodiments described herein may be implemented in software, hardware, firmware, or in some combination thereof. The secondary content system 130 may include memory 530, processor 544 I/O interfaces 548, other computer-readable media 550, and network connections 552.

Processor 544 may include one or more central processing units, circuitry, or other computing components or units—collectively referred to as a processor or one or more processors—that are configured to performed embodiments herein or to execute computer instructions to perform embodiments described herein. In some embodiments, a single processor may operate individually to perform embodiments described herein. In other embodiments, a plurality of processors may operate to collectively perform embodiments described herein, such that one or more processors may operate to perform some, but not all, of the embodiments described herein.

Memory 530 may include one or more various types of non-volatile and/or volatile storage technologies. Examples of memory 530 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 530 may be utilized to store information, including computer-readable instructions that are utilized by Processor 544 to perform actions, including embodiments described herein.

Memory 530 may have stored thereon website category generation module 210 and secondary content selection module 202. The website category generation module 210 is configured to train and generate a category-determination model based on website information obtained from the pre-labeled website categories 212, the archived website content 214, and the presidential speeches dataset 216, as described herein. In various embodiments, the website category generation module 210 may employ the category-determination model to predict a category for a website, as described herein.

The secondary content selection module 202 includes a secondary content request module 204 and a secondary content fulfillment module 206. The secondary content request module 204 is configured to coordinate with the website category generation module 210 to obtain a predicted category for a website associated with a secondary content request, as described herein. And the secondary content fulfillment module 204 is configured to select secondary content for the request based on the predicted category, as described herein. Memory 530 may also store viewership information 230, secondary content database 232, and other programs and data (e.g., operating systems, user demographic information, etc.). The viewership information 230 may store data regarding various shows and their viewership to be used by the secondary content fulfillment module 206 to select a secondary content. The secondary content database 232 may store a plurality of separate content to be selected by the secondary content fulfillment module 206.

Network connections 552 are configured to communicate with other computing devices, such as secondary content server 224 in FIG. 2. In various embodiments, the network connections 552 include transmitters and receivers (not illustrated) to send and receive data as described herein. I/O interfaces 548 may include one or more data input or output interfaces, video or display interfaces, or other input/output interfaces. Other computer-readable media 552 may include other types of stationary or removable computer-readable media, such as removable flash drives, external hard drives, or the like.

The following is a summarization of the claims as filed.

A method may be summarized as comprising: receiving a secondary content request for a target website being presented to a user; employing a category-determination model to determine a category for the target website; determining a plurality of top shows for the category; selecting a show from the plurality of top shows; selecting secondary content for the target website based on the selected show; and providing the selected secondary content to the user via the target website.

The method may further comprise employing a machine learning mechanism to train the category-determination model using pre-labeled categories for a plurality of websites and historical content presented on the plurality of websites.

The method may further comprise employing a machine learning mechanism to train the category-determination model using pre-labeled categories for a plurality of websites, historical content presented on the plurality of websites, and presidential speech information.

The method may further comprise dynamically training the category-determination model in response to receiving the secondary content request.

The method may further comprise receiving feedback on the effectiveness of the secondary content and re-training the category-determination model based on the received feedback.

The method may determine the plurality of top shows for the category by selecting a number of shows associated with the category having a highest viewership for a selected period of time.

The method may employ the category-determination model to determine the category for the target website by scraping the target website to obtain current content of the target website; generating at least one vector of the current content based on frequency of words within the current content; and employing the at least one vector as input to the category-determination model to output the category for the target website.

A computing system may be summarized as comprising a memory configured to store computer instructions and a processor configured to execute the computer instructions to: receive a secondary content request for a target website being presented to a user; employ a category-determination model to determine a category for the target website; determine a plurality of top shows for the category; select a show from the plurality of top shows; select secondary content for the target website based on the selected show; and provide the selected secondary content to the user via the target website.

The processor of the system may be configured to further execute to the computer instructions to: employ a machine learning mechanism to train the category-determination model using pre-labeled categories for a plurality of websites and historical content presented on the plurality of websites.

The processor of the system may be configured to further execute to the computer instructions to: employ a machine learning mechanism to train the category-determination model using pre-labeled categories for a plurality of websites, historical content presented on the plurality of websites, and presidential speech information.

The processor of the system may be configured to further execute to the computer instructions to: dynamically train the category-determination model in response to receiving the secondary content request.

The processor of the system may be configured to further execute to the computer instructions to: receive feedback on the effectiveness of the secondary content and re-train the category-determination model based on the received feedback.

The processor of the system may be configured to determine the plurality of top shows for the category by further executing to the computer instructions to: select a number of shows associated with the category having a highest viewership for a selected period of time.

The processor of the system may be configured to employ the category-determination model to determine the category for the target website by further executing to the computer instructions to: scrape the target website to obtain current content of the target website; generate at least one vector of the current content based on frequency of words within the current content; and employ the at least one vector as input to the category-determination model to output the category for the target website.

A non-transitory computer-readable storage medium may be summarized as storing instructions that, when executed by a processor in a computing system, cause the processor to perform actions, the actions comprising: receiving a secondary content request for a target website being presented to a user; employing a category-determination model to determine a category for the target website; determining a plurality of top shows for the category; selecting a show from the plurality of top shows; selecting secondary content for the target website based on the selected show; and providing the selected secondary content to the user via the target website.

The instructions of the non-transitory computer-readable storage medium, when executed by the processor, cause the processor to perform further actions, the further actions comprising: employing a machine learning mechanism to train the category-determination model using pre-labeled categories for a plurality of websites and historical content presented on the plurality of websites.

The instructions of the non-transitory computer-readable storage medium, when executed by the processor, cause the processor to perform further actions, the further actions comprising: employing a machine learning mechanism to train the category-determination model using pre-labeled categories for a plurality of websites, historical content presented on the plurality of websites, and presidential speech information.

The instructions of the non-transitory computer-readable storage medium, when executed by the processor, cause the processor to perform further actions, the further actions comprising: dynamically training the category-determination model in response to receiving the secondary content request.

The instructions of the non-transitory computer-readable storage medium, when executed by the processor, cause the processor to perform further actions, the further actions comprising: receiving feedback on the effectiveness of the secondary content; and re-training the category-determination model based on the received feedback.

The instructions of the non-transitory computer-readable storage medium, when executed by the processor to employ the category-determination model to determine the category for the target website, cause the processor to perform further actions, the further actions comprising: scraping the target website to obtain current content of the target website; generating at least one vector of the current content based on frequency of words within the current content; and employing the at least one vector as input to the category-determination model to output the category for the target website.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a secondary content request for a target website being presented to a user;
employing a category-determination model to determine a category for the target website;
determining a plurality of top shows for the category;
selecting a show from the plurality of top shows;
selecting secondary content for the target website based on the selected show; and
providing the selected secondary content to the user via the target website.

2. The method of claim 1, further comprising:
employing a machine learning mechanism to train the category-determination model using pre-labeled categories for a plurality of websites and historical content presented on the plurality of websites.

3. The method of claim 1, further comprising:
employing a machine learning mechanism to train the category-determination model using pre-labeled categories for a plurality of websites, historical content presented on the plurality of websites, and presidential speech information.

4. The method of claim 1, further comprising:
dynamically training the category-determination model in response to receiving the secondary content request.

5. The method of claim 1, further comprising:
receiving feedback on the effectiveness of the secondary content; and
re-training the category-determination model based on the received feedback.

6. The method of claim 1, wherein determining the plurality of top shows for the category further comprises:
selecting a number of shows associated with the category having a highest viewership for a selected period of time.

7. The method of claim 1, wherein employing the category-determination model to determine the category for the target website further comprises:
scraping the target website to obtain current content of the target website;
generating at least one vector of the current content based on frequency of words within the current content; and
employing the at least one vector as input to the category-determination model to output the category for the target website.

8. A computing system, comprising:
a memory configured to store computer instructions; and
a processor configured to execute the computer instructions to:
receive a secondary content request for a target website being presented to a user;
employ a category-determination model to determine a category for the target website;
determine a plurality of top shows for the category;
select a show from the plurality of top shows;
select secondary content for the target website based on the selected show; and
provide the selected secondary content to the user via the target website.

9. The system of claim 8, wherein the processor is configured to further execute to the computer instructions to:
employ a machine learning mechanism to train the category-determination model using pre-labeled categories for a plurality of websites and historical content presented on the plurality of websites.

10. The system of claim 8, wherein the processor is configured to further execute to the computer instructions to:
employ a machine learning mechanism to train the category-determination model using pre-labeled categories for a plurality of websites, historical content presented on the plurality of websites, and presidential speech information.

11. The system of claim 8, wherein the processor is configured to further execute to the computer instructions to:
dynamically train the category-determination model in response to receiving the secondary content request.

12. The system of claim 8, wherein the processor is configured to further execute to the computer instructions to:
receive feedback on the effectiveness of the secondary content; and
re-train the category-determination model based on the received feedback.

13. The system of claim 8, wherein the processor is configured to determine the plurality of top shows for the category by further executing to the computer instructions to:
select a number of shows associated with the category having a highest viewership for a selected period of time.

14. The system of claim 8, wherein the processor is configured to employ the category-determination model to determine the category for the target website by further executing to the computer instructions to:
scrape the target website to obtain current content of the target website;
generate at least one vector of the current content based on frequency of words within the current content; and
employ the at least one vector as input to the category-determination model to output the category for the target website.

15. A non-transitory computer-readable storage medium that stores instructions that, when executed by a processor in a computing system, cause the processor to perform actions, the actions comprising:
receiving a secondary content request for a target website being presented to a user;
employing a category-determination model to determine a category for the target website;
determining a plurality of top shows for the category;
selecting a show from the plurality of top shows;
selecting secondary content for the target website based on the selected show; and
providing the selected secondary content to the user via the target website.

16. The non-transitory computer-readable storage medium of claim 15, wherein the instructions, when executed by the processor, cause the processor to perform further actions, the further actions comprising:
employing a machine learning mechanism to train the category-determination model using pre-labeled categories for a plurality of websites and historical content presented on the plurality of websites.

17. The non-transitory computer-readable storage medium of claim 15, wherein the instructions, when executed by the processor, cause the processor to perform further actions, the further actions comprising:
employing a machine learning mechanism to train the category-determination model using pre-labeled categories for a plurality of websites, historical content presented on the plurality of websites, and presidential speech information.

18. The non-transitory computer-readable storage medium of claim 15, wherein the instructions, when executed by the processor, cause the processor to perform further actions, the further actions comprising:
dynamically training the category-determination model in response to receiving the secondary content request.

19. The non-transitory computer-readable storage medium of claim 15, wherein the instructions, when executed by the processor, cause the processor to perform further actions, the further actions comprising:
receiving feedback on the effectiveness of the secondary content; and
re-training the category-determination model based on the received feedback.

20. The non-transitory computer-readable storage medium of claim 15, wherein the instructions, when executed by the processor to employ the category-determination model to determine the category for the target website, cause the processor to perform further actions, the further actions comprising:
scraping the target website to obtain current content of the target website;
generating at least one vector of the current content based on frequency of words within the current content; and
employing the at least one vector as input to the category-determination model to output the category for the target website.
